(19) United States
(12) Patent Application Publication
(10) Pub. No.: US 2010/0280909 A1
(43) Pub. Date: Nov. 4, 2010

(54) PROVIDER-DRIVEN PAYMENT ADAPTER PLUG-IN TO PAYMENT GATEWAY

(75) Inventors: Junbo Zhang, Beijing (CN); Jay Tze, Beijing (CN); Eric Zheng, Beijing (CN); Belinda Wu, Beijing (CN); Lois Wang, Beijing (CN)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/431,790

(22) Filed: Apr. 29, 2009

(51) Int. Cl. G06Q 20/00; G06Q 40/00

(52) U.S. Cl. 705/17; 705/39; 705/21

(57) ABSTRACT

A payment gateway is implemented as a web service that utilizes a payment adapter plug-in model to support both synchronous payments (e.g., credit/debit card payments) and asynchronous payments (e.g., bank transfers) in which an interface to the payment gateway is provided to facilitate the development by a payment service provider or third party of a payment adapter that can plug into the gateway. The payment adapter enables the details of the payment service provider, credit card network, bank, etc. to be abstracted by mapping payment status from the provider to a standardized payment status that is utilized by the payment gateway. A payment gateway can then switch payment service providers by switching payment adapters.

### BACKGROUND

The term electronic commerce (“e-commerce”) commonly applies to the purchase and sale of goods or services that involves the transfer of orders and payments over networks including the Internet. It can cover a broad range of businesses from consumer-orientated web sites that sell items like electronics, books, and music to business-to-business transactions among corporations.

E-commerce lowers barriers so that buyers and sellers can complete transactions without regard to time zones or geographic distance. The volume of e-commerce transactions has grown rapidly and is anticipated to continue to expand as both consumers and businesses increasingly look to the Internet as a means to effectively facilitate purchases of goods and services conveniently, safely, and with minimal transaction costs.

The payment service providers that process transactions (and clear and settle accounts) have grown prodigiously in recent years in both number and variety. However, connecting a web site, for example, to a payment service provider can be complex and is typically beyond the expertise and technical resources of most merchants. As a result, merchants will often utilize a payment gateway for accepting electronic payments from credit and debit cards, electronic checks, and the like.

A payment gateway provides the interface to the infrastructure, which is generally complex, that is usually necessary to ensure fast, reliable, and secure automated processing of transactions. Payment gateways free merchants from dealing with the various details and levels of payment service providers, credit card networks, banks, and other financial institutions that underlie the processing of virtually all electronic transactions. Merchants can simply focus on selling goods and services and leave the details of the transaction to the payment gateway. For example, after receiving an online order, once the payment gateway verifies that a transaction has been successfully completed (so that payment will be received at the merchant's bank upon settlement) the merchant can ship the goods to the customer.

The underlying levels of infrastructure can vary considerably over time and distance in terms of market coverage, the functionalities and services that are supported, fees, payment service provider maturity and continuity, and a host of other factors. Switching among different payment service providers, networks and/or banks can thus be a common task for payment gateways in order to provide the level of service that merchants demand. As a result, payment gateways provide a significant benefit to both merchants and customers by making the complexity of payment transactions transparent. Such gateways are expected to facilitate the continued growth of e-commerce.

This Background is provided to introduce a brief context for the Summary and Detailed Description that follow. This Background is not intended to be an aid in determining the scope of the claimed subject matter nor be viewed as limiting the claimed subject matter to implementations that solve any or all of the disadvantages or problems presented above.

### SUMMARY

A payment gateway is implemented as a web service that utilizes a payment adapter plug-in model to support both synchronous payments (e.g., credit/debit card payments) and asynchronous payments (e.g., bank transfers) in which an interface to the payment gateway is provided to facilitate the development by a payment service provider or third party of a payment adapter that can plug into the gateway. The payment adapter enables the details of the payment service provider, credit card network, bank, etc. to be abstracted by mapping payment status from the provider to a standardized payment status that is utilized by the payment gateway. A payment gateway can then switch payment service providers by switching payment adapters.

In various illustrative examples, the payment gateway and adapter plug-in respectively utilize functionalities that may be implemented using software code that is operable on computing platforms such as web servers, including a payment gateway container and adapter interface. The payment gateway container includes a web service API (application programming interface) that exposes functions to the merchant and payment service provider, a file processor for sending and retrieving files from the payment adapter and for processing the files, and a database for storing transaction data and payment events. The adapter interface is implemented by the payment adapter to abstract payment provider-specific logic and expose various functions to the payment gateway and return payment events.

Advantageously, the payment adapter plug-in model substantially improves the speed at which payment solutions can be brought to market. By supporting a common interface to the payment gateway for all the payment adapters, the responsibility and cost for the payment adapter implementation can be shifted to the payment service provider who will have the most familiarity with the low level details of their particular payment solution. Payment adapters can also be developed by third parties and/or in parallel to quickly bring new payment methods to merchants and customers.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### DESCRIPTION OF THE DRAWINGS

FIG. 1 shows an illustrative e-commerce environment which supports various elements including a customer, merchant, payment gateway, payment service provider, credit card network, and banks;

FIG. 2 shows details of an illustrative merchant that supports sales through a variety of channels;

FIGS. 3 and 4 show a typical method by which transactions are processed and settled in the e-commerce environment shown in FIG. 1;

FIG. 5 shows an illustrative payment adapter plug-in model by which the lower levels of payment processing are abstracted using an adapter that plugs into the payment gateway;

FIG. 6 shows details of an illustrative payment gateway container;

FIG. 7 shows details of an illustrative payment adapter;

FIG. 8 includes a table showing illustrative functions exposed by the web service API;

FIG. 9 includes a table showing illustrative functions exposed by the adapter interface API; and

FIGS. 10-12 are UML (Unified Modeling Language) diagrams that respectively show illustrative sequences of function calls among the various elements in the e-commerce environment.

Like reference numerals indicate like elements in the drawings. Elements are not drawn to scale unless otherwise indicated.

### DETAILED DESCRIPTION

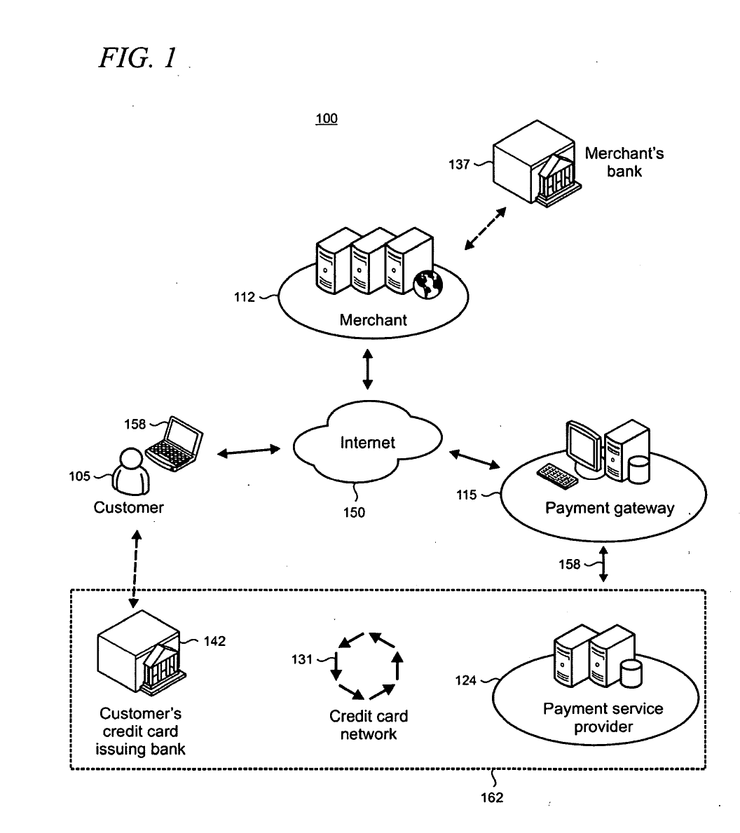

FIG. 1 shows an illustrative e-commerce environment 100 which supports various elements including a customer 105, merchant 112, payment gateway 115, payment service provider 124, credit card network 131, and banks. The banks in the e-commerce environment 100 include a merchant bank 137 that provides a bank account for the merchant and a credit card issuing bank 142 that issues a credit card to the customer 105.

It is noted that while a credit card transaction is utilized in the particular example described below, the e-commerce environment 100 can typically support a variety of conventional instrumentalities that are processed for electronic payment including debit cards, charge cards, ATM (automated teller machine) cards, electronic check payments, bank transfers, and the like. It is further noted that for sake of clarity of illustration only single instances of the customer 105, merchant 112, payment service provider 124, credit card network 131, and banks 137 and 142 are shown. However, the e-commerce environment 100 will typically support multiple customers and merchants, and a wide variety of payment service providers, financial networks, banks, and other financial institutions can be utilized to process the transactions and associated payments that occur in the environment.

The customer 105, merchant 112, and payment gateway 115 are coupled over a network such as a wide area network like the Internet 150 in this example. However, a variety of network types may also be utilized including private networks, telephone networks, etc. as may be required to meet the needs of a particular usage scenario. Connectivity to the Internet 150 facilitates the completion of a transaction between the customer 105 and merchant 112 in which the merchant provides goods or services in exchange for a payment from the customer. For example, the customer 105 may use a PC 158 that supports a web browser to connect to an online store or web site operated by the merchant 112.

Upon placement of an order, the merchant 112 will typically utilize automated order handling to transact a charge against the customer's credit card through the payment gateway 115. As indicated by the arrow 158, the payment gateway 115 will interact with the payment service provider 124, credit network 131, and bank 142 (collectively indicated by reference numeral 162) to process the payment. Confirmation of the payment from the payment gateway 115 will then allow the merchant 112 to ship the order to the customer 105.

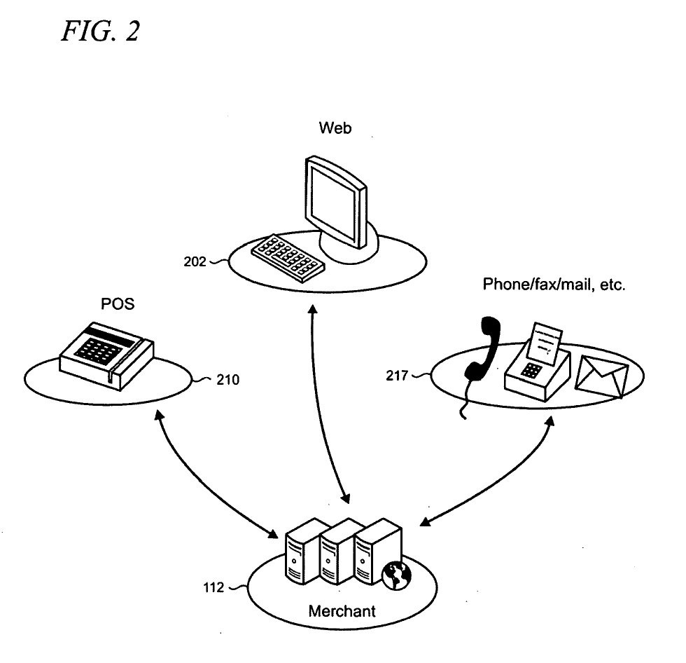

As shown in FIG. 2, in addition to web-based sales (indicated by reference numeral 202), the merchant 112 may also support sales through other channels where electronic payments need to be processed. These can include point-of-sale (“POS”) 210 and traditional channels such as sales by telephone, facsimile, mail, etc. 217.

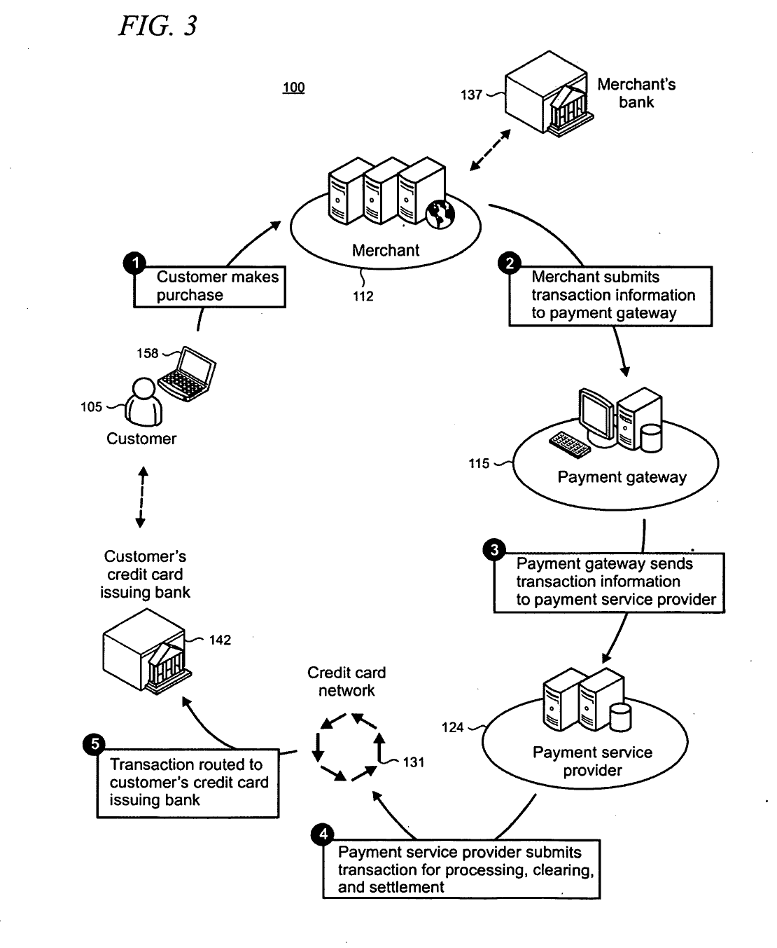

FIGS. 3 and 4 show the typical steps taken when processing electronic payments in the e-commerce environment 100. The process begins at step 1 when a customer 105 makes a purchase of goods or services from the merchant 112 for example by placing an order over a secure connection on the Internet to the merchant's web site and charging the purchase to a credit card. At step 2, the merchant 112 transacts the charge by submitting the transaction to the payment gateway 115 for processing. The payment gateway 115 receives the transaction and other pertinent information (e.g., account number, merchant ID, transaction amount, etc.) from the merchant 112 at step 3 and passes it over a secure Internet connection to an appropriate payment service provider 124 (among the many possible payment service providers) that deals with the merchant's bank 137.

At step 4, the payment service provider 124 will submit the transaction to the credit card network 13 1. The credit card network 131 is a network of financial entities that interact for processing, clearing, and settlement of credit card transactions. For example, if the customer 105 is using a Visa® branded credit card, the transaction will be referred to Visa's network. Typically, there can often be multiple credit card networks that may be available and supported in the e-commerce environment 100.

At step 5 in the payment processing, the credit card network 131 will route the transaction to the customer's credit card issuing bank 142. The bank 142 will check the account and confirm that the customer 105 has sufficient available credit to cover the purchase.

At step 6 in FIG. 4, the bank 142 will approve (or when appropriate, decline) the transaction and pass those results to the credit card network 13 1. The network, in turn, passes the results to the payment service provider 124 at step 7, which are received by the payment gateway 115 at step 8. The payment gateway 115 will typically store the transaction and then notify the merchant 112 (or in some cases the customer 105) of the results of the credit card transaction at step 9. Generally, steps 1 to 9, which constitute the process of transaction authorization, can take place in just a few seconds of time.

The settlement process comprises the credit card issuing bank 142 sending the appropriate funds to the credit card network 131 at step 10. Then, the credit card network 131 will deposit the funds into the merchant's account at the merchant's bank 137 at step 11. Unlike the authorization process which normally takes place in near real-time as transactions occur, settlement is typically a batch process. For example, the merchant 112 will perform a batch at the end of the sales day to confirm, settle, and clear all credit card transactions with the payment service provider 124 and prepare for the next day. After the batch is complete, the merchant's bank account can receive the funds from the customer's credit card account, generally within a couple of business days.

The foregoing description accompanying FIGS. 3 and 4 shows the complexity of the payment processing that is shared among a number of parties. While the customer 105 only needs to deal with a relatively simple process of providing authorization for the payment and then receiving a statement or bill, the merchant 112 is faced with many decisions and potential difficulties when dealing with authorization and settlement. For example, accounting, security, and performance are typical concerns of merchants.

The payment gateway 115 will typically hide the complexity of the underlying infrastructure from the merchant 112 as well as the details of the authorization and settlement processes. The payment gateway 115 can also act as a broker by allowing the merchant 112 to switch among payment service providers, or add new payment service providers (for example, to accept other card types or instruments). The merchant 112, for example, may wish to switch to a different payment service provider to minimize service fees or gain other service features, sell into a new or different geographic region, or gain additional flexibility when servicing customers.

Currently, a payment gateway provider would typically need to engage in some type of customized development in order to integrate a new payment service provider into its offerings to merchants. The provider, for example, could use its own development team or outsource the development to some third party. In both cases the engineering processes utilized often lead to lengthy development cycles, particularly as integration is repeated to bring new solutions to bear. These development cycles and their associated expense can lead to situations where migration of payment service providers and the development of new solutions become challenging and prevent or slow the integration of some payment service providers. As a result, payment gateway providers run the risk that their services can become unsatisfactory or uncompetitive in the e-commerce environment.

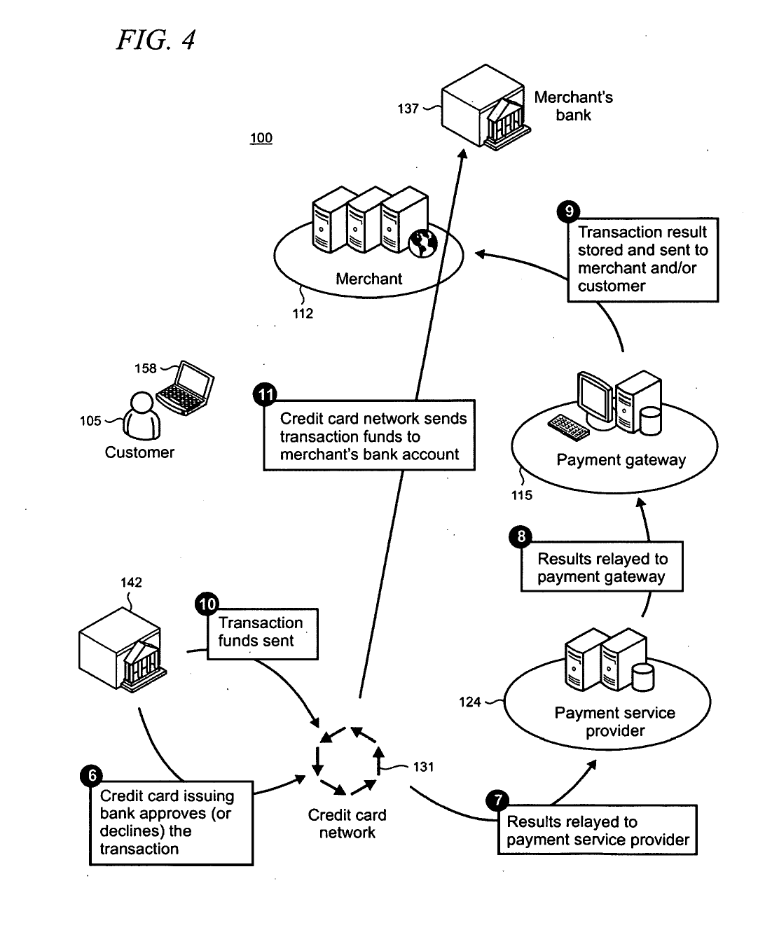

The present provider-driven payment adapter plug-in model addresses the problem of payment solution migration and integration by supporting an additional layer of abstraction in the e-commerce environment. As shown in FIG. 5, the payment gateway 115 currently provides an abstraction of the payment handling (as indicated by reference numeral 503 to the merchant 112). In addition, in accordance with the principles of the present arrangement, a payment adapter 505 enables the lower level details—including for example, the bank issuing the customer's credit card, the credit card network, and the payment service provider—to be abstracted to the payment gateway (as indicated by reference numeral 515).

Although a single payment adapter 505 and a single set of lower level elements is shown for sake of clarity in FIG. 5, the current model contemplates the utilization of a multiplicity of adapters that abstract the details of different elements in varying combinations. The payment adapters are arranged as plug-ins to the payment gateway 115 so that a given payment status from the lower levels of infrastructure can be expressed using a standardized payment status 521 through the interface to the payment gateway 115. Thus, by mapping the payment status from the lower level to the standardized payment status used by the payment gateway 115, new or switched payment service providers can be readily integrated into payment solutions from the payment gateway 115.

The payment adapter model further enables new business and technology development paradigms to be created. Here, for example, the model facilitates the ownership of the payment adapter development to be placed with the payment service provider, or a third party in some implementations. This placement can mean that the entity that is often the most knowledgeable of the particular lower level details is positioned to drive the development of the solution. A provider-driven payment adapter model can thus shorten development lead time while improving performance and reliability of the solution. Payment adapters can also be developed in parallel to provide further time savings.

The model utilizes several components including a payment gateway container and the payment adapter 505. In this example, the components are implemented using software code that is executable on computing platforms such as servers that may be operated by the payment gateway 115 and/or payment service provider 124, and/or a third party host.

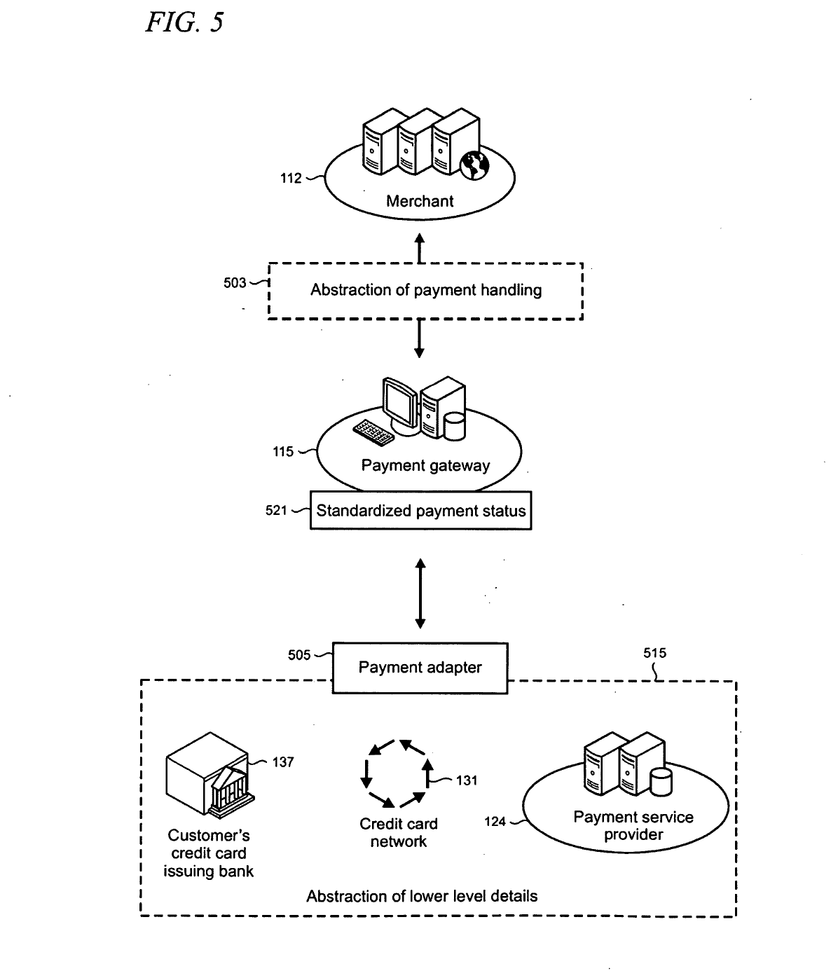

As shown in FIG. 6, the payment gateway container 606 exposes a web service API 620 that may be invoked by systems operated by the merchant 112 and/or payment service provider 124 in an automated manner. A database 626 for storing various transaction data 630 (such as persisted data like charged amounts) and payment events 634 is included in the payment gateway container 606. A file processor 641 is also included and is configured to interface with the payment adapter to send, retrieve, and/or process files.

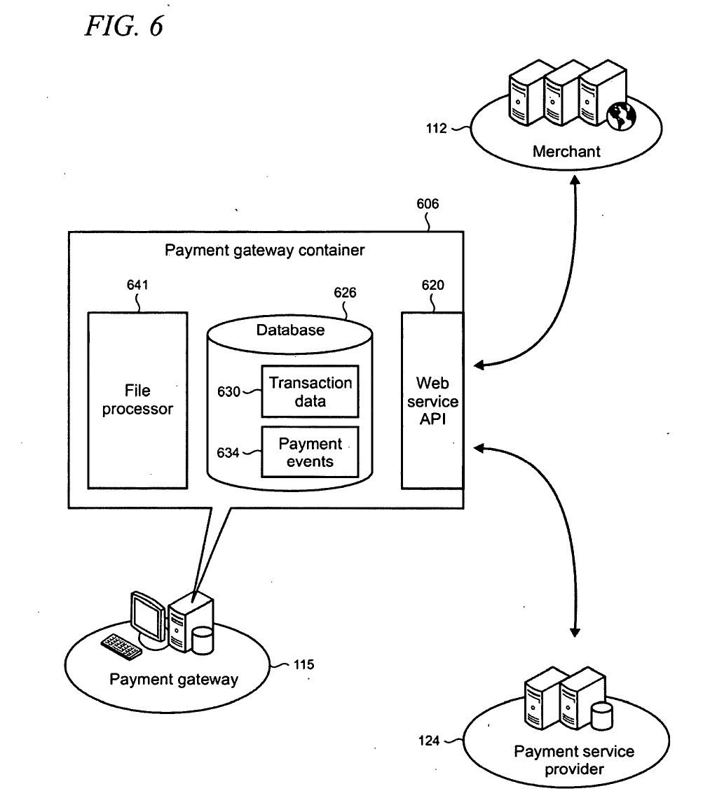

The payment adapter 505 is arranged to include an adapter interface API 707, as shown in FIG. 7 that operates to abstract the payment provider-specific logic 713 that the adapter encapsulates. The adapter interface API 707 may be invoked by the payment gateway container 606 and/or the file processor 641.

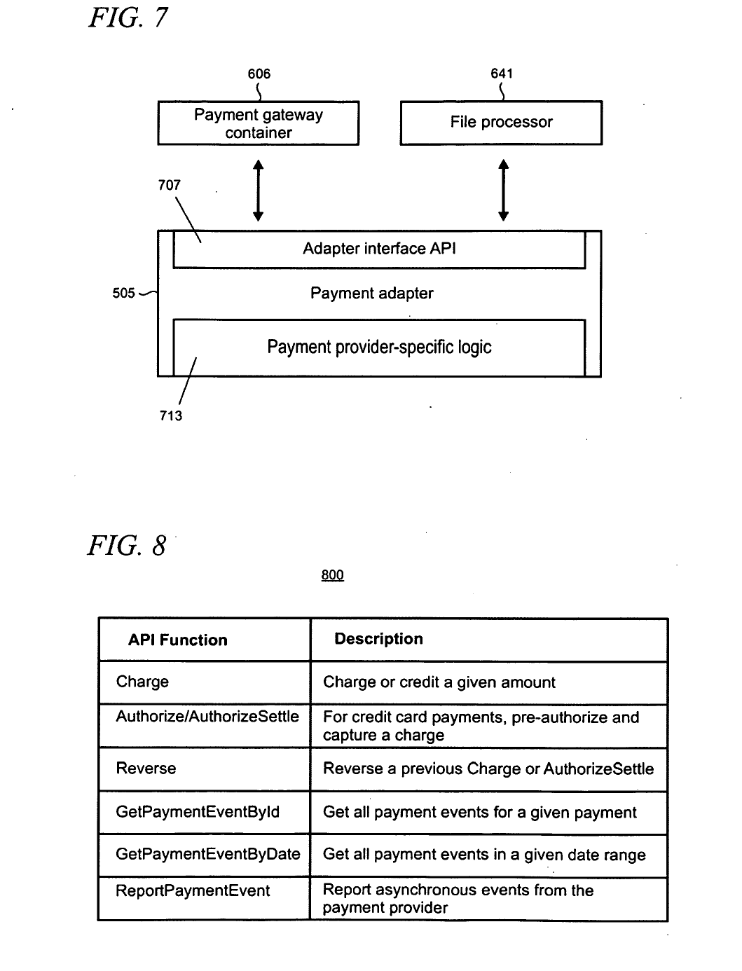

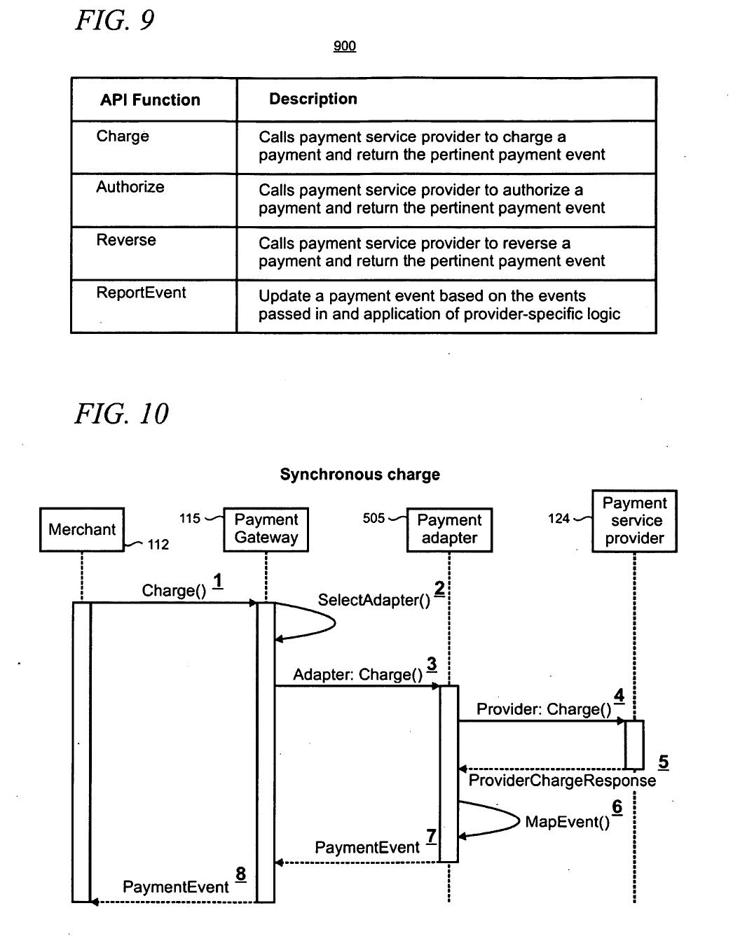

FIGS. 8 and 9 show tables of illustrative functions and associated descriptions that may be respectively exposed by the web service API 620 in the payment gateway container 606 and the payment adapter interface API 707. It is noted that the functions are intended to be illustrative and that other functions may be utilized as needed to meet the needs of a particular implementation. In FIG. 8, the functions in table 800 include Charge, Authorize/AuthorizeSettle, Reverse, GetPaymentEventById, and GetPaymentEventbyDate which may be invoked by the Merchant 112 to authorize, settle, and manage payments. The payment gateway 115 will perform the functions shown in FIG. 8 when invoked and return a payment event (i.e., a notification from a source in the lower levels) to the merchant 112 to thereby provide status for a given payment or set of payments.

The ReportPaymentEvent function may be invoked by the payment gateway 115 to report payments to the merchant 112 from the payment service provider 124. These events represent asynchronous payments which are not transacted in near real time as with credit cards that could include payments such as bank transfers and those made in response to invoices.

In FIG. 9, the functions in table 900 including Charge, Authorize, Reverse, and ReportEvent are exposed by the adapter interface API 707 (FIG. 7). The payment gateway container 606 (FIG. 6) or file processor 641 can invoke the appropriate functions in response to the invocations of the analogous functions exposed by the web service API. That is, the functions represent the glue between the payment gateway and the provider-specific logic that is utilized by the payment adapter 505 (FIG. 5) so that transactions received at the payment gateway from the merchant 112 can be processed by the payment service provider 124.

When Charge, Authorize, and Reverse functions in table 900 are invoked, a call will be made to the payment service provider 124 to trigger the appropriate action. The payment service provider 124 will return a response event through the adapter interface API 707 to the payment adapter 505 when an action is successfully completed. The payment adapter 505 will apply payment provider-specific logic to map the returned response event into a standard payment event that is usable by the payment gateway 115.

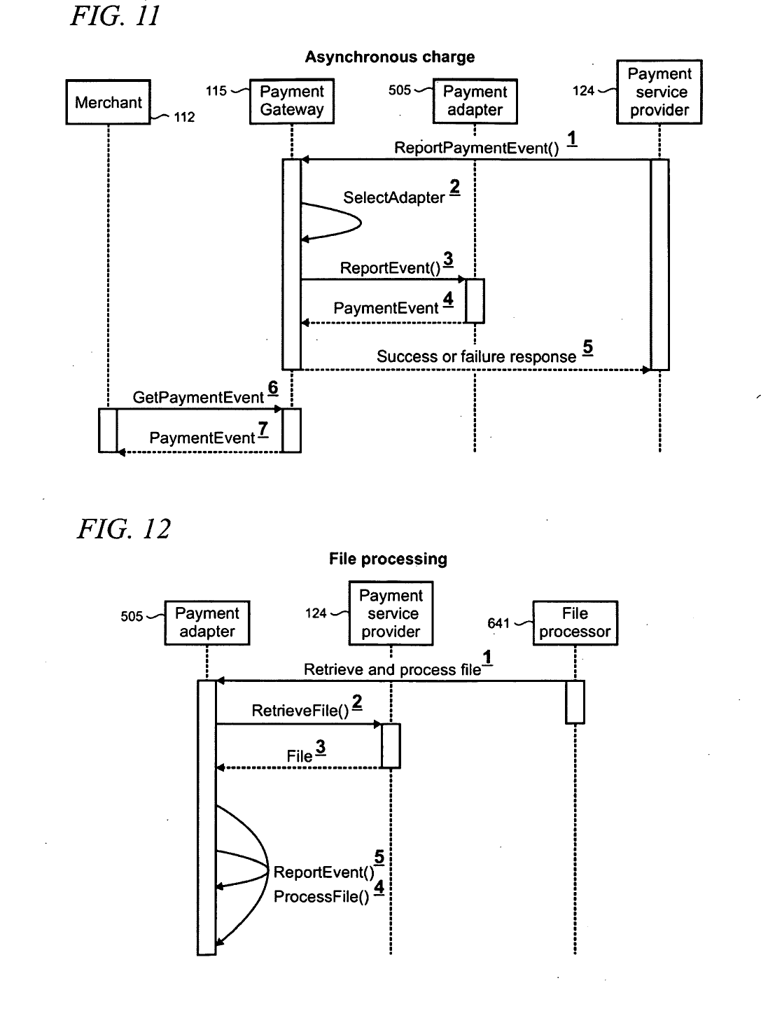

FIGS. 10-12 are UML diagrams that respectively show illustrative sequences of function calls among the various elements in the e-commerce environment 100. In FIG. 10, the calls illustrate a synchronous charge that can typically occur when a customer pays for a transaction by credit card, debit card, electronic check, and the like. At the first call in the sequence (represented by the reference numeral 1) in FIG. 10, the merchant 112 will call Charge( ) and specify the amount of the charge (which is typically expressed in some local currency, e.g., U.S. dollars, Euros, etc.). At 2, the payment gateway 115 will select a payment adapter among the available adapters using the method SelectAdapter that is appropriate for the transaction by taking into account the merchant, card type, and other factors as may be required so that the correct adapter interface API can be called.

At 3, the payment gateway 115 passes the charge to the payment adapter 505 which, in turn relays the charge to the payment service provider 124 at 4. At 5, the payment service provider 124 returns a response, ProviderChargeResponse, back to the payment adapter 505. At 6, the payment adapter 505 uses the method MapEvent( ) to map the response returned from the payment service provider 124 into a standardized payment event, PaymentEvent, that is returned to the payment gateway 115 at 7. The payment gateway 115 passes the event to merchant 112 at 8 to provide payment status, for example that the customer charge was authorized by the payment service provider 124.

FIG. 11 shows an illustrative sequence of function calls associated with an asynchronous charge. At step 1 in the sequence, the payment service provider 124 calls the ReportPaymentEvent( ) API exposed by the web service API in the payment gateway 115 and passes the amount of the asynchronous charge. The payment gateway 115 selects an appropriate adapter at 2 to call its adapter interface API. The payment gateway 115 reports the asynchronous payment to the payment adapter 505 using ReportEvent( ) at 3, and the adapter returns a standardized payment event (i.e., a payment event that indicates the standardized payment status), PaymentEvent at 4. The payment gateway 115 returns a response as to the success or failure of the creation of the payment event to the payment service provider 124 at 5. When the merchant 112 invokes GetPaymentEvent from the web service API at 6, the payment gateway will return PaymentEvent at 7 to indicate the status of the asynchronous payment using a standardized payment status.

FIG. 12 shows an illustrative sequence of function calls associated with operations of the file processor 641. At step 1 in the sequence, the file processor 641 calls the interface API exposed by the payment adapter 505 when seeking to retrieve and process a file. At 2, the payment adapter 505 will invoke RetrieveFile( ) and pass the appropriate parameters (e.g., file name, etc.) to the payment service provider 124 which returns the requested file at 3. The payment adapter 505 will process the retrieved file at 4 and update a payment event in response (when appropriate) by calling ReportEvent( ) at 5.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. One or more computer-readable storage media containing instructions which, when executed by one or more processors disposed in an electronic device, perform a method for implementing a web service on a payment gateway, the method comprising the steps of:
selecting a payment adapter as a plug-in to the payment gateway, the payment adapter being configured for exposing a payment adapter API to the payment gateway and for applying payment service provider-specific logic responsively to calls to the API from the payment gateway;
receiving transaction data from a merchant, the merchant utilizing the payment gateway to authorize and settle electronic payments;
placing calls to the payment adapter API responsively to the transaction data; and
receiving a payment event from the payment adapter that provides payment status for transaction processing by the payment service provider.

2. The one or more computer-readable storage media of claim 1 in which the method includes a further step of exposing a web service API to the merchant and the payment service provider, the web service API being configured for receiving the transaction data and payment event when invoked.

3. The one or more computer-readable storage media of claim 1 in which the method includes a further step of implementing a database to store the transaction data and the payment event.

4. The one or more computer-readable storage media of claim 1 in which the method includes a further step of implementing a file processor, the file processing being configured for calling the payment adapter API to retrieve and process files from the payment service provider.

5. The one or more computer-readable storage media of claim 1 in which the electronic payments are associated with a synchronous charge or an asynchronous charge.

6. The one or more computer-readable storage media of claim 5 in which the payment service provider reports a payment event for the asynchronous charge by calling the web service API.

7. The one or more computer-readable storage media of claim 1 in which the transaction data is associated with one of online transaction or point-of sale (POS) transaction.

8. One or more computer-readable storage media containing instructions which, when executed by one or more processors disposed in an electronic device, perform a method for implementing a payment adapter as a plug-in to a payment gateway, the method comprising the steps of:
exposing a payment adapter API to the payment gateway and a payment service provider;
receiving a payment event from the payment service provider; and
applying payment service provider-specific logic to map the payment event from the payment service provider to a standardized payment status usable by the payment gateway.

9. The one or more computer-readable storage media of claim 8 in which the payment event comprises a notification of status of payment processing performed by the payment service provider.

10. The one or more computer-readable storage media of claim 8 including a further step of exposing the payment status to a merchant via the payment gateway.

11. The one or more computer-readable storage media of claim 8 in which the payment adapter plugs in to a standardized interface in the payment gateway so that a plurality of different payment adapters are supportable by the payment gateway.

12. The one or more computer-readable storage media of claim 8 in which the payment gateway and payment adapter are developed by different entities.

13. The one or more computer-readable storage media of claim 8 in which the method includes a further step of receiving calls from the payment gateway to transact a merchant charge.

14. The one or more computer-readable storage media of claim 8 including a further step of configuring the payment adapter to retrieve files from the payment service provider in response to a call to the payment adapter API from a file processor in the payment gateway.

15. An automated method operable on a computing platform for implementing an adapter plug-in model for abstracting low-level payment processing from a payment gateway, the method comprising the steps of:
implementing a payment gateway as a web service that is accessible by a merchant to transact a charge;
providing an interface on the payment gateway to which a payment adapter is plugged in, the payment adapter being configured to abstract the low-level payment processing by applying payment-provider specific logic to map payment events from the low-level payment processing to payment status that is exposed to the merchant; and
selecting one of a plurality of payment adapters to facilitate payment processing for the charge.

16. The automated method of claim 15 in which the low-level processing is performed by a combination of payment service provider, credit card network, and bank.

17. The automated method of claim 16 in which the charge is a synchronous charge associated with at least one of credit card, debit card, or electronic check.

18. The automated method of claim 16 in which the charge is an asynchronous charge associated with at least one of bank transfer or invoice.

19. The automated method of claim 18 in which the web service is further accessible by the payment service provider to report the asynchronous charge to the payment gateway.

20. The automated method of claim 15 in which each of the plurality of payment adapters is configured for different combinations of payment service providers, credit card networks, and banks.
